(19) United States
(12) Patent Application Publication
(10) Pub. No.: US 2010/0001447 A1
(43) Pub. Date: Jan. 7, 2010

(54) Air-Damped Engine Mount

(75) Inventors: JEONG HOON KIM, Seoul (KR); HEAN JUNG SHIN, Daegu (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Pyung HWA Industrial Co., Ltd., Daegu (KR)

(21) Appl. No.: 12/494,030

(22) Filed: Jun. 29, 2009

(30) Foreign Application Priority Data
Jul. 2, 2008 (KR) 10-2008-0064057

(51) Int. Cl. F16F 9/00

(52) U.S. Cl. 267/140.11

(57) ABSTRACT

An air-damped engine mount may include a core boss coupled with an engine of a vehicle, a main rubber coupled with the core boss and elastically supporting the core boss, a hollow main pipe tightly coupled with the main rubber and supporting the main rubber, and a cover plate tightly coupled with one end portion of the main pipe to form a damping chamber in a space between the cover plate and the main rubber, wherein the core boss defines at least an air track allowing the damping chamber to fluid-communicate with the outside therethrough such that vibration in the engine is damped by flow resistance against air passing through the air track.

### CROSS-REFERENCE TO RELATED APPLICATION

The present application claims priority to Korean Patent Application Number 10-2008-0064057 filed on Jul. 2, 2008, the entire contents of which is incorporated herein for all purposes by this reference.

### BACKGROUND OF THE INVENTION

1. Field of the Invention

The present invention relates to an air-damped engine mount. More particularly, the present invention relates to an air-damped engine mount, in which an air track capable of increasing flow resistance against air is formed inside a core boss coupling with an engine, such that increased flow resistance against air enhances an effect of damping vibration in the engine, the air track is not clogged ensuring a normal operation even if moisture on the bottom of the damping chamber is frozen, and characteristics of damping vibration in the engine can be easily adjusted when necessary.

2. Description of Related Art

In general, an engine mount used for mounting an engine to a body of a vehicle has functions of not only connecting and supporting the engine to the vehicle body but also absorbing vibration or noise from the engine, which would otherwise be transmitted to the vehicle body.

As conventional engine mounts having those functions, a fluid-filled engine mount (or hydraulic engine mount) and a rubber engine mount are widely used. The fluid-filled engine mount defines therein a fluid chamber filled with fluid such as oil. The rubber mount does not define therein the fluid chamber, with its entire body made of solid rubber.

The rubber engine mount made of solid rubber consists of a small number of parts, leading to merits such as a simple fabrication process and a cheap cost. However, the problems of the rubber engine mount are that it may not sufficiently absorb vibration and noise due to poor damping efficiency.

The fluid-filled engine mount defining therein the fluid chamber filled with fluid can sufficiently absorb vibration and noise due to high damping efficiency. However, the fluid-filled engine mount have problems such as a complicated fabrication process and a considerably expensive cost since a fluid-sealing structure is required.

In order to overcome the foregoing drawbacks of the fluid-filled engine mount and the rubber engine mount, an air-damped engine mount performing pneumatic damping has been recently developed.

FIG. 1 is a schematic cross-sectional view illustrating the structure of a typical air-damped engine mount of the related art.

As shown in FIG. 1, the typical air-damped engine mount of the related art includes a core boss 10 coupling with an engine of a vehicle via a center bolt 11 fitted into the center of the core boss 10, a main rubber 20 into the central portion of which the core boss 10 is fitted and coupled such that the main rubber 20 elastically supports the core boss 10, a hollow main pipe 30 tightly coupled with the main rubber 20 while supporting the main rubber 20 and a cover plate 40 tightly coupled with one end of the main pipe 30 to form a damping chamber 50 in a space between the cover plate 40 and the main rubber 20.

The cover plate 40 has an air hole 41 allowing the damping chamber 50 to fluid-communicate with the outside. Specifically, outside air enters the damping chamber 50 through the air hole 41 or inside air exits the damping chamber 50 through the air hole 41.

The air entering and exiting the damping chamber 50 serves to reduce vibration in the main rubber 20. In more detail, the main rubber 20 changes the pressure inside the damping chamber 50 when deformed by vibration in the engine, so that the air exits or enters through the air hole 41. The exiting or entering air causes a pressure change and flow resistance, which in turn reduce vibration in the main rubber.

However, in the air-damped engine mount constructed as above, the flow resistance against the entering and exiting air is very small due to direct communication with the outside through the air hole 41 and thereby the effect of damping the vibration in the engine is not sufficient. In addition, the air hole 41 may be clogged by impurities when the engine is running or be clogged with frozen moisture in the winter. In both cases, the air-damped engine mount fails to properly reduce vibration in the engine.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an air-damped engine mount, in which an air track capable of increasing flow resistance against air is formed inside a core boss coupling with an engine, such that increased flow resistance against air enhances an effect of damping vibration in the engine, the air track is not clogged ensuring a normal operation even if moisture on the bottom of the damping chamber is frozen, and characteristics of damping vibration in the engine can be easily adjusted when necessary.

In one aspect of the present invention, the air-damped engine mount, may include a core boss coupled with an engine of a vehicle; a main rubber coupled with the core boss and elastically supporting the core boss; a hollow main pipe tightly coupled with the main rubber and supporting the main rubber; and a cover plate tightly coupled with one end portion of the main pipe to form a damping chamber in a space between the cover plate and the main rubber, wherein the core boss defines at least an air track allowing the damping chamber to fluid-communicate with the outside therethrough such that vibration in the engine is damped by flow resistance against air passing through the air track.

One end portion of the air track may be formed on a lateral side of the core boss disposed outside the damping chamber, wherein an air track adaptor may be fitted into the other end portion of the air track, the air track adaptor defining therein an air flow hole.

The air track may have at least a vertical channel extending in a longitudinal direction of the core boss from an entrance section, at which the air from the damping chamber begins to enter the air track, wherein an air track adaptor may be fitted into the entrance section of the air track, the air track adaptor defining therein an air flow hole and wherein the air track has at least a horizontal channel horizontally diverging from an end portion of the vertical channel.

In another aspect of the present invention, the air-damped engine mount may further include an air track adaptor fitted into the air track and tightly contacted with an inner circumference of the air track, the air track adaptor defining therein an air flow hole.

In still another aspect of the present invention, the cover plate may be dented towards the main rubber to decrease the space of the damping chamber and a porous breathable member may be installed between the dented portion of the cover plate and the main rubber inside the damping chamber, the breathable member absorbing and exhausting the air in response to a change in pressure inside the damping chamber wherein the breathable member is made up of porous breathable member.

According to various aspects of the present invention, the air track capable of increasing flow resistance against air is formed inside the core boss coupling with an engine, such that increased flow resistance against air enhances an effect of damping vibration in the engine, the air track is not clogged ensuring a normal operation even if moisture on the bottom of the damping chamber is frozen, and characteristics of damping vibration in the engine can be easily adjusted when necessary.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic cross-sectional view illustrating the structure of a typical air-damped engine mount of the related art.

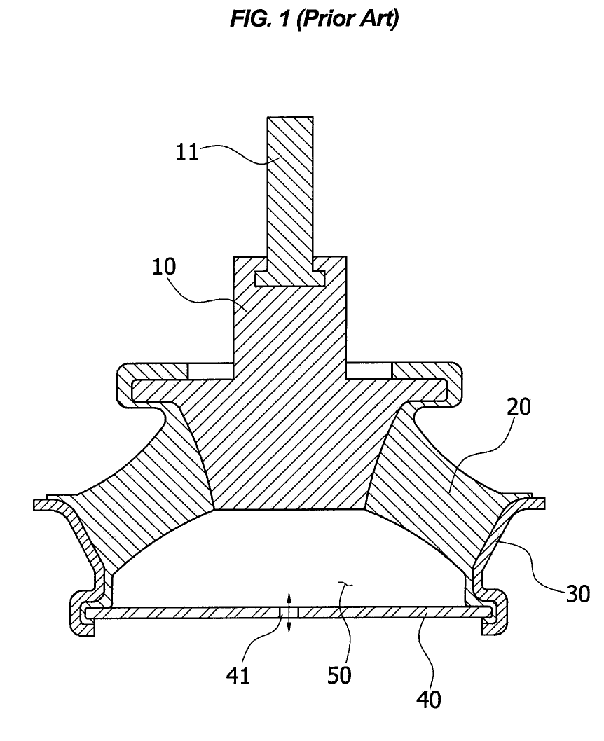

FIG. 2 is a schematic cross-sectional view illustrating the structure of an exemplary air-damped engine mount according to the present invention.

FIG. 3 is a schematic cross-sectional view illustrating the structure of an exemplary air-damped engine mount according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

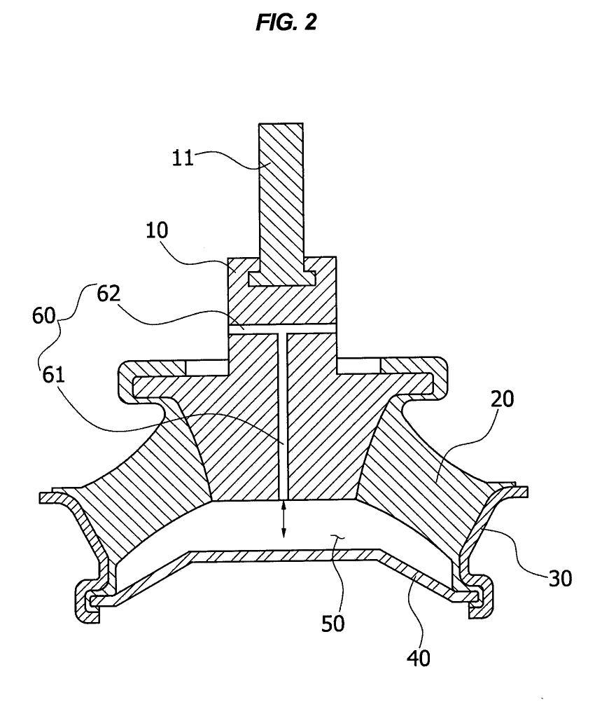

FIG. 2 is a schematic cross-sectional view illustrating the structure of an air-damped engine mount according to various exemplary embodiments of the present invention.

As shown in FIG. 2, the typical air-damped engine mount according to various exemplary embodiments of the present invention includes a core boss 10 coupling with an engine of a vehicle using a center bolt 11 fitted into the center of the core boss 10, a main rubber 20 into the central portion of which the core boss 10 is fitted and coupled such that the main rubber 20 elastically supports the core boss 10, a hollow main pipe 30 tightly coupled with the main rubber 20 while supporting the main rubber 20 and a cover plate 40 tightly coupled with one end portion of the main pipe 30 to form a damping chamber 50 in a space between the cover plate 40 and the main rubber 20.

Here, the core boss 10 has an air track 60 allowing the damping chamber 50 to communicate with the outer space as shown in FIG. 2. The air-damped engine mount according to various embodiments of the invention is constructed to reduce vibration in the engine using flow resistance against air passing through the air track 60. Unlike the related art in which the air hole is formed in the cover plate 40 to circulate the air, the air track 60 for circulating the air is formed inside the core boss 10. The air track 60 can increase the flow resistance against the air to thereby increase the effect of damping vibration in the engine.

The air track 60 can be provided in various forms inside the core boss 10 to increase the flow resistance against the air exiting and entering through the air track 60. According to various embodiments of the invention, the air track 60 includes a vertical channel 61 extending in the vertical direction of the core boss 10 from an entrance section, at which the air from the damping chamber 50 begins to enter the air channel 60. The vertical channel 61 may be formed to directly communicate with the outer space. Alternatively, as shown in FIG. 2, the air track 60 can also include horizontal channels 62 horizontally diverging in both directions from the vertical channel 61 in order to allow communication with the outer space.

According to various embodiments of the invention, some dimensions of the vertical channel 61 such as an inner diameter and a length can be adjusted to vary damping characteristics of the air-damped engine mount in order to reduce various types of vibration in the engine. The damping characteristics can also be varied by changing the shape of the horizontal channel 62 in addition to changing the shape of the vertical channel 61. Alternatively, the damping characteristics can be varied by changing the shape of the air track 60 into, for example, a spiral shape instead of forming the vertical and horizontal channels in the air track 60.

In the air-damped engine mount according to various embodiments of the invention, the air track 60 inside the core boss 10 can be formed in a variety of shapes to increase the flow resistance against the air. In addition, since the air track 60 is formed above the damping chamber 50, for instance, on a lateral side of the core boss 10, even if moisture and the like collected on the bottom inside the damping chamber 50 is frozen, the air track 60 can normally operate without being clogged.

In addition, as shown in FIG. 2, the cover plate 40 according to various embodiments of the invention is not formed flat but can be formed in a depressed shape, which is curved or bent towards the main rubber 20 to reduce the space of the damping chamber 50. The space of the damping chamber 50 is then decreased compared to the related art to increase the flow rate of the air passing through the air track 60. This, as a result, may make the entering and exiting actions of the air more sensitive and thereby enhance damping characteristics for engine vibration.

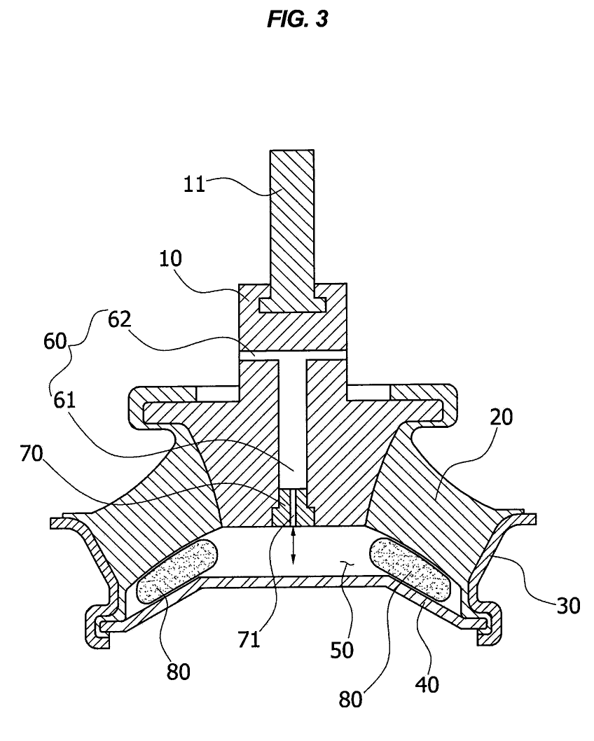

FIG. 3 is a schematic cross-sectional view illustrating the structure of an air-damped engine mount according to various embodiments of the invention.

As shown in FIG. 3, the air-damped engine mount according to various embodiments of the invention can also include an air track adaptor 70, which is inserted into the air track 60 to be in tight contact with the inner circumference of the air track 60. The air track adaptor 70 has an air flow hole 71, which extends through the air track adaptor 70.

The air track adaptor 70 may be fitted into the entrance of the air track 60, which adjoins the damping chamber 50. The air track adaptor 70 is constructed to be easily fitted into or removed from the air track 60. Due to this structure, users can easily substitute different types of air track adaptors 70 when necessary. In other words, various types of the air track adaptors 70 are provided with different types of air flow holes 71 having different diameters or shapes, so that individual air track adaptors 70 can have different characteristics for damping vibration in the engine. Accordingly, the air-damped engine mount according to various embodiments of the invention is enabled to reduce various types of vibration in the engine only when the air track adaptor 70 is substituted into different types.

According to various embodiments of the invention, a porous breathable member 80 can be installed inside the damping chamber 50, the breathable member 80 capable of absorbing and exhausting air in response to changes in pressure inside the damping chamber. The breathable member 80 can be made of a porous urethane foam.

When the inner space of the damping chamber 50 is deformed by vibration in the engine to change the pressure inside the inner space, the air inside the damping chamber 50 is further absorbed into or exhausted from the breathable member. In this case, the air absorbed into or exhausted from the breathable member 80 instantaneously causes flow resistance, thereby damping vibration in the engine. Accordingly, the air-damped engine mount according to various embodiments of the invention can reduce vibration in the engine not only using the flow resistance against the air created by the air track 60 but also the flow resistance against the air created when the breathable member 80 absorbs and exhausts the air.

For convenience in explanation and accurate definition in the appended claims, the terms “horizontal” and “vertical” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air-damped engine mount comprising:
a core boss coupled with an engine of a vehicle;
a main rubber coupled with the core boss and elastically supporting the core boss;
a hollow main pipe tightly coupled with the main rubber and supporting the main rubber; and
a cover plate tightly coupled with one end portion of the main pipe to form a damping chamber in a space between the cover plate and the main rubber;
wherein the core boss defines at least an air track allowing the damping chamber to fluid-communicate with the outside therethrough such that vibration in the engine is damped by flow resistance against air passing through the air track.

2. The air-damped engine mount according to claim 1, wherein one end portion of the air track is formed on a lateral side of the core boss disposed outside the damping chamber.

3. The air-damped engine mount according to claim 2, further comprising an air track adaptor fitted into the other end portion of the air track, the air track adaptor defining therein an air flow hole.

4. The air-damped engine mount according to claim 1, wherein the air track has at least a vertical channel extending in a longitudinal direction of the core boss from an entrance section, at which the air from the damping chamber begins to enter the air track.

5. The air-damped engine mount according to claim 4, further comprising an air track adaptor fitted into the entrance section of the air track, the air track adaptor defining therein an air flow hole.

6. The air-damped engine mount according to claim 4, wherein the air track has at least a horizontal channel horizontally diverging from an end portion of the vertical channel.

7. The air-damped engine mount according to claim 1, further comprising an air track adaptor fitted into the air track and tightly contacted with an inner circumference of the air track, the air track adaptor defining therein an air flow hole.

8. The air-damped engine mount according to claim 1, wherein the cover plate is dented towards the main rubber to decrease the space of the damping chamber.

9. The air-damped engine mount according to claim 8, further comprising a porous breathable member installed between the dented portion of the cover plate and the main rubber inside the damping chamber, the breathable member absorbing and exhausting the air in response to a change in pressure inside the damping chamber.

10. The air-damped engine mount according to claim 9, wherein the breathable member is made up of porous breathable member.

11. The air-damped engine mount according to claim 1, further comprising a porous breathable member installed inside the damping chamber, the breathable member absorbing and exhausting the air in response to a change in pressure inside the damping chamber.

12. The air-damped engine mount according to claim 11, wherein the breathable member is made up of porous breathable member.

13. A vehicle engine comprising the air-damped engine mount according to claim 1.
